(19) United States
(12) Patent Application Publication
(10) Pub. No.: US 2012/0273386 A1
(43) Pub. Date: Nov. 1, 2012

(54) TRANSPORT CONTAINER WITH CUSHIONING STRUCTURE

(75) Inventors: Keinosuke Miyazaki, Tokyo (JP); Keishi Yamada, Tokyo (JP)

(73) Assignee: Deutsche Post AG, Bonn (DE)

(21) Appl. No.: 13/509,588

(22) PCT Filed: Nov. 11, 2009
(86) PCT No.: PCT/EP2009/008041

§ 371 Date: Jul. 13, 2012

(51) Int. Cl. B65D 81/02; B23P 23/00; B65B 1/04

(52) U.S. Cl. 206/591; 53/473; 29/401.1

(57) ABSTRACT

A cushioning structure is provided for transporting large fragile goods, comprising a main frame with contiguous bearing surface, carrier foil attached to the main frame fully covering the bearing surfaces and area enclosed by the bearing surface as a carrying surface for the goods main frame comprises multiple foldable inner and outer side flaps to be folded into multiple supporting elements of connected inner and outer side flaps to support the bearing surface of the main frame with a height defined by the dimensions of the outer side flaps and having a profile to increase resilience of the main frame for carrying goods with weights of more than 25 kg and collapsible into a two-dimensional structure. A container is also provided that is reducible in size comprising the cushioning structure, a method to load the goods into the container and a method to collapse the empty container.

### CROSS REFERENCE TO RELATED APPLICATIONS

Pursuant to 35 U.S.C. §371, this application is the U.S. National Stage Application of International Patent Application No. PCT/EP2009/008041, filed on Nov. 11, 2009, the contents of which are incorporated by reference as if set forth in their entirety herein.

### BACKGROUND

A large variety of containers for shipping goods are available. Fragile goods or sensitive equipments are secured against mechanical impacts acting on the container during shipment. Therefore containers are commonly filled with packaging material to absorb an eventual impact, e.g. different kinds of foam arranged between container wall and goods. This packaging material is commonly a one-way-material. Currently, there is strong demand to save resources and consequently to provide containers and packaging material that are used frequently. Simultaneously, the containers and/or packaging material are light material in order to reduce the transport costs. Light containers made of foldable corrugated cardboard as cushioning structure recently introduced as packaging. To be able to ship fragile goods safely, the goods are placed in between two polyethylene (PE) foils fixed onto two corrugated cardboard frames. Unfortunately, the usage of cardboard frames is limited to small and light goods of a few kilograms of weight and having a freight volume below 100 liter. There is a demand to ship fragile and heavy goods with sizes of more than 200 liter. Prior art foldable containers are inappropriate to transport such goods.

### SUMMARY

The subject innovation relates to a cushioning structure for transporting heavy, large and fragile goods, a container reducible in size comprising the cushioning structure, a method to load the goods into the container and a method to collapse the empty container.

The subject innovation provides a cushioning structure for safely transporting heavy, large and fragile goods comprising a main frame with a contiguous bearing surface, a carrier foil attached to the main frame at least fully covering the bearing surface and the area enclosed by the bearing surface as a carrying surface for the goods, wherein the main frame comprises multiple foldable inner and outer side flaps able to be folded into multiple supporting elements of connected inner and outer side flaps to support the bearing surface of the main frame with a height defined by the dimensions of the outer side flaps and having a profile to increase the resilience of the main frame for carrying goods with weights of more than 25 kg and being collapsible into a two-dimensional structure in case of absent goods. Beside multiple items to be transported, the term “goods” also comprises one single item to be transported. The term “contiguous” denotes a continuously connected area. Mathematically, this contiguous area is an area, where a first point inside this area can be connected to any other point inside this area by a continuous line without said continuous line leaving this area. Cushioning structures with a contiguous bearing surface supported by the supporting elements are able to carry heavier goods compared to other cushioning structures of similar dimensions with non-contiguous bearing surfaces with a carrier foil attached to the non-contiguous bearing surfaces. The load is distributed over a larger bearing surface in case of a contiguous bearing surface resulting in a lower load per bearing area.

The foldable inner and outer flaps provide sufficient support for the bearing surface of the main frame if folded into the supporting elements having any profile to carry weight, such as, a tubular shape with a rectangular cross section. The foldable inner and outer side flaps provide a foldable cushioning structure, which can be in a two-dimensional shape (structure) or a three-dimensional shape (structure) when folded as the supporting elements. The flexibility to provide the same cushioning structure as a flat structure or as three-dimensionally shaped structure enables a transport of non-loaded cushioning structure in a flat and therefore volume-saving manner. The term “folded supporting elements” denotes a three-dimensional structure established by the inner and outer side flaps in a folded manner. The terms “inner side flap” and “outer side flap” refer to the direction of the side flaps with respect to the contiguous bearing surface of the main frame in the non-folded status. The Inner side flaps are fully enclosed by the contiguous bearing surface, when the main frame is in the two-dimensional shape. The outer side flaps direct to the opposite direction of the inner side flaps. The non-folded status denotes the cushioning structure being in a two-dimensional shape. Thus the empty two-dimensional cushioning structure (absent goods) can be transported and/or stored in a space saving manner. The carrier foil may extend over the bearing surfaces, e.g. also partly of fully covering the outer side flaps.

The shape of the main frame can be any shape to transport the desired good. The area between the bearing surfaces and therefore the area of the carrier foil may vary depending on the goods to be transported. As an example, the carrying surface of the carrier foil may have areas of 0.25 m2, 0.36 m2, 0.49 m2, 0.72 m2, 1.00 m2. In one embodiment, the material of the carrying foil may be any material, e.g. polyethylene or urethane.

The lateral extension of the outer side flaps corresponds to the height of the supporting element in the folded status. For a safe transport of the goods preventing mechanical impacts from the outside acting on the transported goods, the height of the cushioning structure (=height of the supporting element) may be at least in the order of a few centimeters, e.g. 4 cm, 6 cm, 8 cm or 10 cm. A too large height may result in a bulky container for transporting the goods on the cushioning structures, although other heights may be used.

The bearing surface and the inner and outer side flaps of the main frame may be made of any material for multiple uses. As an example, plastic material can be used as material providing a cushioning structure. The components of the main frame except the carrier foil are made of the same material. The previously mentioned components may be made of pressed paperboard providing a sufficient resilience to carry heavy good and being able to be recycled after reaching the end of life as cushioning structure after multiple uses. Such cushioning structures of pressed paperboard can be used more than 100 times before replacement. The replaced cushioning structures can be recycled and re-used afterwards. In one embodiment, other materials may be used for the main frame, the inner and outer side flaps. Before recycling, the carrier foil may be detached from the main frame.

In an embodiment, the bearing surface of the main frame has a rectangular shape with a first, a second, a third and a fourth part, wherein the first part is opposite to the third part and the second part is opposite to the forth part and each of the parts comprise one of the foldable inner side flaps facing towards the foldable side flap of the opposite part in a non-folded status, preferably with inner side flaps having a triangular shape, more with inner side flaps having a shape like a trapezium. The term “opposite” denotes the location of the parts within the main frame, not the orientation of the surfaces of the parts. Here, opposite parts are arranged essentially in one plane all facing upwards or downwards depending on the orientation of the main frame. A square shape of the main frame is a particular embodiment of the rectangular shape. As an example the rectangular area of the main frame may be 96 cm×65 cm, although other sizes may be used. However, a rectangular shape consumes a small loading space (or volume) if this structure is loaded (stacked) together with other corresponding structures in a transport vehicle and/or container. Transport efficiency may be achieved with rectangular shapes of shipped items such as cushioning structure or containers with correspondingly adapted shaped to comprise such cushioning structures avoiding empty interspaces within a loading volume.

In another embodiment, the main frame comprises at least one corner element, such as an L-shaped corner element, fixed to the bearing surface of the main frame in at least one corner, or each corner, of the main frame to strengthen the main frame. The corner element may be fixed to the main frame with mechanical and/or chemical fasteners, e.g. rivets riveted from both sides (side of corner element and lower side of main frame). The main frame may be sandwiched between the corner element on top of the bearing surface and a second corner element arranged on the opposite side of the main frame below the corner element to further improve the strength (loadability) of the main frame. Here the rivets fix both corner elements to the main frame. The corner element as well as the second corner element may be made of any material to improve the strength of the cushioning structure such as metal and/or plastic elements. In one embodiment, the corner element is made of pressed paperboard capable of being recycled. The corner elements may be L-shaped corner elements in case of rectangular bearing surfaces of the main frame.

In another embodiment, the areas, of the outer side flaps are smaller than the areas of the inner side flaps. Since the inner flaps can occupy the full area between the bearing structures of the main frame, the areas of the inner side flaps are designed larger than the areas of the outer side flaps in order to build the same supporting elements to achieve a cushioning structure occupying a smaller total area compared to cushioning structures, where the areas of the outer side flaps are larger than the areas of the inner side flaps. The required space to transporting non-folded two-dimensional cushioning structures is reduced leading to a more efficient transporting.

In another embodiment, the supporting elements are established by the inner and outer side flaps, which are attached to each other, for example, by hook-and-loop fasteners, per corresponding inner and outer side flaps. The term “established” denote the folding-together (joining) of the inner and outer side flaps to build the support elements. The term “fixation means” (either first or second) denotes any kind of means able to connect (join) two parts, preferably a hook-and-loop fasteners comprising fasteners having hooks and loops, Velcro fasteners, fasteners with mushroom heads or the like. The first fixation means are attached to the inner and/or outer side flaps with means such as rivets or adhesive tapes. The corresponding first fixation means of inner and outer side flap will hold the corresponding outer and inner side flaps together. The mounting of the first fixation means to the inner and outer side flaps has no influence on the bonding strength of inner and outer side flap established by the first fixation means, although. Other first fixations of the hook-and-loop-fasteners may be used. The first fixation means, e.g. the hook-and-loop fasteners, may be attached to the inner and/or outer side flaps at any location, such as on the inner side flap at the largest distance to the main frame and aligned to the middle of the corresponding bearing surface. Depending on the dimensions of the inner side flap, the corresponding counterpart of the first fixation means, e.g. the hook-and-loop fastener, may be arranged on a location at the outer side flap. Alternatively, the corresponding counterpart may also be arranged on the bearing surface of main frame.

In an embodiment the neighbored outer side flaps are connected to each other by at least one second fixation means, preferably hook-and-loop fasteners, arranged on the outer surface of at least two outer side flaps, preferably of each of the outer side flaps. The term “outer surface” denotes the surface, which is facing away from the volume surrounded by the folded supporting elements in the three-dimensional status of the cushioning structure ready for being loaded with good. Alternatively one or more second fixation means, such as hook-and-loop fasteners, may also be arranged on each outer side flap. In one embodiment, two opposite outer side flaps comprise foldable side areas to be folded around the corner of the supporting element in order to be connected to the corresponding neighbored outer side flap. Here, the second fixation means are arranged on the outer surface of the side areas and on the inner surface of the neighbored outer side flap, or vice versa. The term inner surface denotes the surface of the outer side flap opposite to its outer surface. The second fixation means to connect (join) neighbored outer side flaps may be attached to the outer side flaps in the same manner as previously described first fixation means for inner and outer side flaps.

In another embodiment the support elements have a rectangular tubular profile, which provides resilience against loaded weights.

In another embodiment, the cushioning structure further comprises reinforcement elements separate from the main frame to be inserted into the supporting elements to further increase the resilience of the main frame to carry goods with weights of more than 30 kg, 40 kg, or 50 kg. The reinforcement elements may be made of any material, such as the same material as the main frame and its components (inner and outer side flaps), or pressed paperboard in order to allow a recycling of damaged reinforcement elements. Pressed paperboard allows use of the reinforcement element more than 100 times before replacing the elements. In one embodiment, the reinforcement elements have a profile adapted to the profile of the supporting elements, such as a profile adapted to fit into the supporting elements in a snug fit manner. Resilience may be improved if the profiles of supporting elements and reinforcement elements are fitting together.

In another embodiment, the reinforcement elements are foldable into the profile adapted to the profile of the supporting elements and are collapsible into a two-dimensional structure. Reinforcement elements can be transported in a volume saving manner in a collapsed structure, when the non-loaded cushioning structure is transported. The term “foldable” comprises any kind of folding methods.

In another embodiment, the carrier foil is a urethane foil, being bonded to the main frame by ultrasonic pressure bonding. Urethane foils are known as foil providing a high loading capacity and a high tear-resistance. The urethane foil is fixed to the main frame by a bonding process, e.g. ultrasonic pressure bonding applying pressure and ultrasonic energy to the carrier foil and the bearing surface of the main frame in order to achieve a carrier foil bonded to the bearing surface of the main frame. The fasteners attached to the inner and outer side flaps are not for holding the urethane foil. In one embodiment, the urethane foil comprises open areas not to cover the area for attaching fasteners to the inner and/or outer side flaps. The carrier foil might be bonded to the main frame with two 10 mm wide seal lines around the bearing surface and/or around the outer side flaps. However, in alternative embodiments, the fasteners may by arranged on top of the urethane foil. The fasteners are fixed to the main frame as previously described. Carrier foils attached to the main frame with ultrasonic pressure bonding may not use additional adhesives enabling a removal (easy peel-off) of the carrier foil from the main frame without any remaining residues on the main frame improving its ease of recyclability.

The subject innovation further relates to a container for safely transporting heavy, large and fragile goods comprising a bottom section, a midsection as a container side wall fitting into the bottom section, at least a first and a second cushioning structure according to the present invention with the first cushioning structure as a bottom element fitting into the midsection and for being placed on top of the bottom section with the carrier foil facing upwards to carry good and with the second cushioning structure for being placed on top of the goods with the carrier foil facing downwards to sandwich the goods between the carrier foils of first and second cushioning structures, and a top section fitting on top of the midsection to close the container. Here the top section is placed on top of the midsection and the second cushioning structure if loaded with goods. During the transport of a container without goods inside, the volume of the container can be reduced and subsequently the top section is placed on top of the bottom section. The midsection may further comprise reinforcement sleeves at the upper and lower edges of the midsection enabling a stacking of the containers of at least 2 meter stacking height. The reinforcement sleeves further improves the reusability (multiple use) of the midsections.

In another embodiment, the bottom section, the top section and the midsection are made of pressed paperboard. Pressed paperboard provides resilience and the possibility of being easily recycled.

In another embodiment, the midsection is foldable fitting into the bottom section in a collapsed status, comprising at least one hook-and-loop fastener to be fixed to the first and/or second cushioning structures. In case of empty containers (=without goods inside), the containers can be transported having a reduced size, because the collapsed midsection is placed inside the container now defined by bottom and top section solely.

In another embodiment, the midsection comprises closing means to be fixed to the top section and/or bottom section in order to improve the robustness of the container during transport. People skilled in the art may choose any fixation means within the scope of this invention, e.g. anchors, hooks, hook-and-loop fasteners, bolts, screws or the like. The closing means enable stacking of the containers of at least 2 meters stacking height.

The subject innovation further relates to a method for loading heavy, large and fragile goods for a safe transport into a container comprising the steps of

placing the midsection on top of the bottom section,

placing the first cushioning structure with folded support elements, comprising reinforcement elements, into the midsection and on top of the bottom section with the carrier foil facing upwards,

placing the to-be-transported goods on top of the carrier foil,

placing the second cushioning structure with folded support elements, comprising reinforcement elements, into the midsection on top of the goods with the carrier foil facing downwards, and

placing the top section over the second cushioning structure and the midsection in order to close the container, secure the closed containers at least one fixation means, such as a securing strap.

The subject innovation further relates to a method for transporting a container without loaded goods

collapsing the foldable midsection

placing the collapsed midsection on top of the bottom section,

collapsing the first and second cushioning structures by unfolding the support elements

placing the first and second cushioning structures on top of the bottom section or on top of the collapsed midsection, together with reinforcement elements of the first and/or second cushioning structures, and

placing the top section over the bottom section in order to close the container reduced in size.

### BRIEF DESCRIPTION OF THE DRAWINGS

FIG. 1 is an embodiment of the cushioning structure according to an embodiment in a non-folded two-dimensional structure (shape);

FIG. 2 is a cushioning structure of FIG. 1 according to an embodiment in a non-folded, two-dimensional structure (shape);

FIG. 3 is a cushioning structure of FIG. 1 according to an embodiment in a folded status (structure) with reinforcement elements to be inserted into the supporting elements;

FIG. 4 is another embodiment of the cushioning structure according to an embodiment in a non-folded two-dimensional structure (shape);

FIG. 5 is a container according to an embodiment transporting goods comprising bottom section, midsection and top section carrying two cushioning structures and goods;

FIG. 6 is a collapsed container according to an embodiment for empty back transport comprising bottom section and top section carrying two cushioning structures and the midsection.

### DETAILED DESCRIPTION OF EMBODIMENTS

FIG. 1 shows an embodiment of a cushioning structure 1 in an unfolded two dimensional structure. The main frame 11 comprises a rectangular contiguous bearing surface 2 defining an inner area, where the inner side flaps 3 as gray areas with trapezium shape are located. The rectangular bearing surface 2 has four parts as subareas defining the shape of a rectangular frame. Each of the four parts of the bearing surface 2 has an inner side flap 3 attached to the bearing surface 2 at its inner side. The term “attached” denotes any kind of fixed connection. The short sides of the trapezoidal inner side flaps are pointing together. Four outer side flaps 4 are arranged at outer sides of the four parts of the rectangular bearing surface 2. The outer side flaps 4 together with the inner side flaps 3 define the supporting elements in a folded status (structure). Advantageously, the folded status is supported by suitable first fixation means 32 and 42 providing a proper connection between inner side flaps 3 and outer side flaps 4. In this embodiment, one first fixation means 32 is arranged on the inner side flap 3 and the corresponding counterpart of the first fixation means 42 is arranged on outer side flap 4. The fixation means 32, 42 might by hook-and-loop-fasteners enabling fast and easy establishment of the supporting structure for the bearing surface 2 of the main frame 11 as well as fast collapsing of the supporting structure to provide a main frame 11 as a two-dimensional structure (shape). The height of the supporting structure of connected inner and outer side flaps (by the fixation means) is defined by the height of the outer side flaps 4. The inner side flaps 3 comprise foldable lines 31 to fold the inner side flaps 3 in order to establish the supporting elements for the bearing surface 2 to provide a cushioning structure 1 ready to be loaded with goods. The carrier foil is not shown in FIG. 1 for ease of understanding.

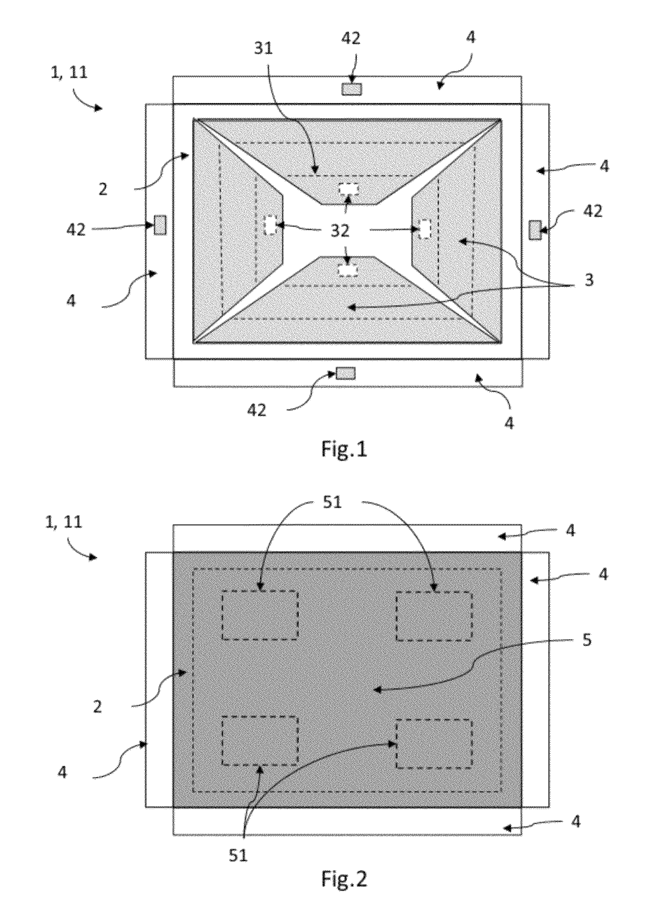

FIG. 2 shows the same cushioning structure as present in FIG. 1, now showing the carrier foil 5 covering the inner side flaps in an unfolded two-dimensional structure of the cushioning structure 1. The inner side flaps arranged below the carrier foil 5 are not shown for ease of understanding. The carrier foil 5 is attached to the main frame 1 with a suitable process, e.g. ultrasonic welding, fully covering the bearing surface 2. Here, the bonding strength between carrier foil 5 and main frame 1 is improved compared to embodiments, where the carrier foil 5 is only attached to parts of the bearing surface 2. An improved bonding strength enables loading of the carrier foil with heavier goods. In other embodiments, the carrier foil 5 may be bonded additionally to at least parts of the outer side flaps 4 to further improve the bonding strength. In one embodiment, the carrier foil 5 comprises carrier foil reinforcements 51, e.g. small additional carrier foils 51 applied to the carrier foil 5 close to the edges of the carrying surface where the highest forces occur, e.g. by gluing the additional foil 51 on top of the carrier foil 5. In this embodiment, the main frame 11 is a one-part piece, where only the carrier foil is attached to the main frame in a second process step. In alternative embodiments, the inner and outer side flaps may be fixed to main frame in another additional process.

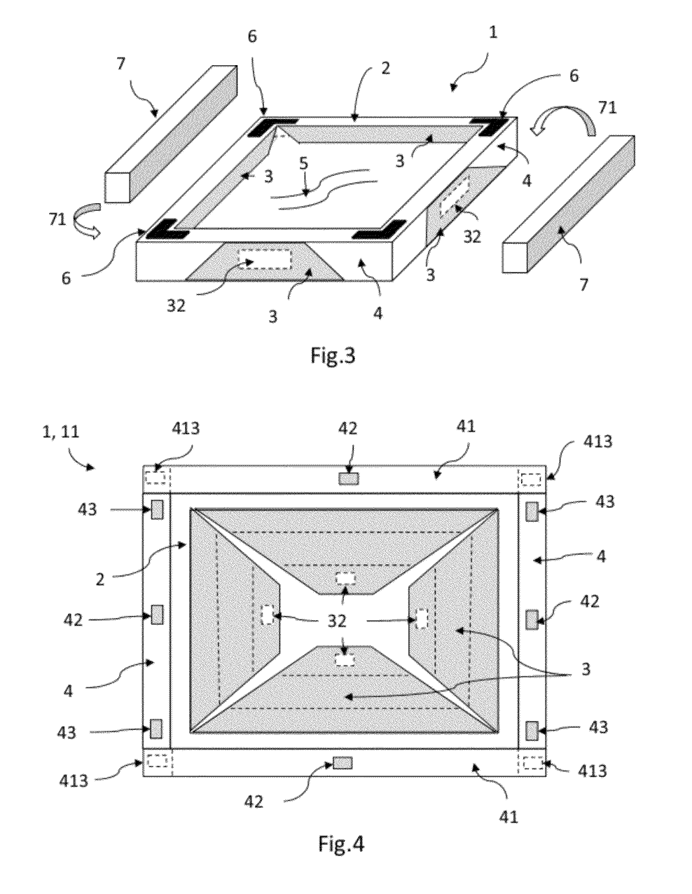

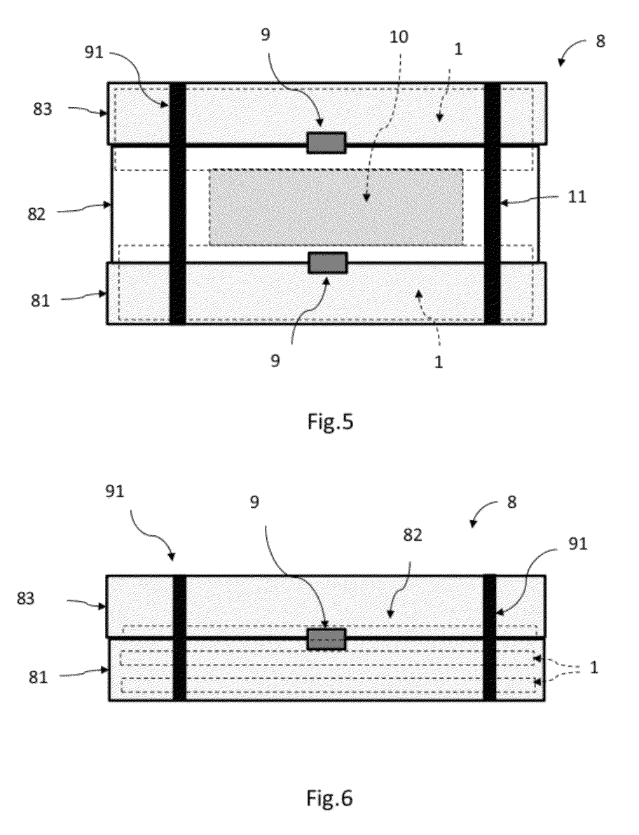

FIG. 3 shows the cushioning structure 1 of FIGS. 1 and 2 in a three-dimensional structure, where the bearing surface 2 of the main frame 11 is supported by the folded inner and outer side flaps 3 and 4 connected to each other by fixation means 32 establishing the supporting elements. The corresponding fixation means 42 of the outer side flaps are covered by the inner side flaps 3 and therefore not shown in this figure. The supporting elements have a rectangular cross section of width and height defined by the height of outer side flap 4 and the width of the bearing surface. The foldable lines 31 of the inner side flaps are adapted to the width of the bearing surface 2 and/or the height of the outer side flap 4. In an embodiment, the main frame 11 comprises one or more corner elements 6, e.g. one corner element 6 in each corner of the bearing surface 2, to strengthen the bearing surface in the corners further improving the loadability of the bearing surface 2. The corner elements 6 might have any shape for the corresponding shape of the bearing surface. For rectangular bearing surfaces, the corner elements 6 may have an L-shape. To further improve the loadability, a corresponding corner element might be arranged at the bottom side of the bearing surface (inside the supporting elements) below the shown corner elements 6. The corner elements can be attached to the bearing surface with any method, e.g. with rivets. The corner elements might be arranged underneath the carrier foil 5 or on top of the carrier foil 5. The carrier foil 5 is indicated by two rolling lines in the middle of the main frame 11. In FIG. 3, the cushioning structure 1 comprises reinforcement elements 7 inside the supporting elements. Since the supporting elements are closed, the reinforcement elements 7 are schematically shown outside the supporting elements for ease of understanding, where arrow 71 shall indicate the intended location of the reinforcement elements 7 inside the supporting elements. Here, only two reinforcement elements 7 are shown. Depending on the required reinforcement of the cushioning structure 1 to carrier the to-be-transported goods, the supporting elements may be reinforced by arranging one, two, three or four reinforcement elements 7 inside the supporting elements. To establish a supporting structure with reinforcement elements 7 inside, the reinforcement elements 7 have to be placed below the bearing surface before folding the inner side flaps 3 around the reinforcement elements 7 in order to be connected with the outer side flaps 4.

FIG. 4 shows another embodiment of the cushioning structure 1, where the outer side flaps 41 of two opposite sides of the bearing surface 2 extend to the outer dimensions of the neighbored outer side flaps 4. The dashed lines at the outer parts of the extended outer side flap 41 indicate, that the extended area can be folded to the neighbored outer side flaps 4 to establish joined supporting elements with improved resilience, because the neighbored outer side flaps 4 and 41 can be fixed together with second fixation means 43 and 413 arranged on the outer sides of the outer side flaps 4 and 41. The second fixation means can be the same kind of fixation means as the first fixation means 32 and 42.

FIG. 5 shows a container 8 according to an embodiment comprising a bottom section 81, a midsection 82 and a top section 83. The midsection 82 fits into the bottom and top sections 81, 83. The midsection is the side wall of the container 8. Depending on the size of the goods, the height of the midsection 82 may be different for different containers 8. Inside the container, two cushioning structures 1 with established supporting elements are arranged. The first cushioning structure 1 fitting into the container 8, especially into the midsection 82, is arranged on top of the bottom section 81. To avoid slippage of the cushioning structure during transport, the sizes of the bottom section 81 and the midsection 82 have to be adapted to the size of the cushioning structure 1. The same holds for the second cushioning structure 1 with respect to midsection 82 and top section 83. The carrier foil 5 of the first cushioning structure 1 is facing upwards to be loaded with goods 10. The goods 10 are placed on top of the carrier foil 5 of the first cushioning structure 1. Subsequently, the second cushioning structure 1 is placed on top of the goods 10 with the carrier foil facing towards the goods 10 (facing downwards). The site of the container is adapted to push the carrier foils 5 of both cushioning structure towards the goods 10 in order to prevent any slippage of the goods 10 on the carrier foils 5 during transport. The bottom, mid and top sections 81, 82, 83 of the container 8 are fixed together with a closing means 9, 91 such as claps, hinges or anchors. Alternatively, one or more transport belts 91 may further prevent the container 8 from being opened accidentally. The midsection 83 may further comprise reinforcement sleeves arranged at the upper and/or lower edges of the midsection 83. Such containers are stackable at least up to 2 meter stacking height. The reinforcement sleeves may be made of a material, such as metal.

After transport, the goods 10 are unloaded from the container 8 and the empty container 8 are returned to another loading facility to be loaded again. The collapsible cushioning structures 1 and a collapsible midsection 82 provide the possibility to reduce the size of the container 8 when being transported empty. The midsection comprises at least two foldable lines in order to be able to collapse the midsection 82, such as one foldable line on each short side of the midsection 82 assuming a container 8 with a rectangular shape of the bottom section 81. The foldable midsection 82 and the first and second cushioning structures 1 are collapsed by unfolding the supporting elements, then the three parts are placed in any sequence on top of the bottom section 81, preferably together with reinforcement elements 7 (collapsed or non-collapsed). The container 8 with reduced size is closed by placing the top section 83 over the bottom section 81. For the empty transport, the same closing means 9, 91 can be used.

While the subject innovation has been illustrated and described in details in the drawings and foregoing description, such illustration and description are to be considered illustrative or exemplary, not restrictive. and not limited to the disclosed embodiments.

1-18. (canceled)

19. A cushioning structure for transporting goods, comprising:
a main frame comprising a contiguous bearing surface, wherein the main frame comprises multiple foldable inner and outer side flaps, wherein the multiple foldable inner and outer side flaps are configured to be folded into multiple supporting elements of connected inner and outer side flaps to support a bearing surface of the main frame with a height defined by dimensions of the outer side flaps, and wherein the main frame comprises a profile to increase resilience of the main frame for carrying goods with weights of more than 25 kg, and wherein the main frame is configured to be collapsible into a two-dimensional structure; and
a carrier foil attached to the main frame, wherein the carrier foil fully covers the contiguous bearing surface, and wherein an area enclosed by the contiguous bearing surface comprises a carrying surface for the goods.

20. The cushioning structure of claim 19, wherein the contiguous bearing surface comprises a rectangular shape comprising a first part, a second part, a third part, and a fourth part, wherein the first part is opposite to the third part and the second part is opposite to the forth part, and wherein each part comprises one of the foldable inner side flaps facing towards a foldable side flap of an opposite part in a non-folded status, and wherein the inner side flaps comprise a shape selected from one of a triangular shape and a trapezium.

21. The cushioning structure of claim 19, wherein the main frame comprises at least one corner element comprising an L-shaped corner element, wherein the corner element is fixed to the contiguous bearing surface in at least one corner of the main frame.

22. The cushioning structure of claim 19, wherein an area of the outer side flaps is smaller than an area of the inner side flaps.

23. The cushioning structure of claim 19, wherein the supporting elements are established by the inner and outer side flaps, and wherein the inner and outer side flaps are attached to each other by hook-and-loop fasteners.

24. The cushioning structure of claim 19, wherein neighboring outer side flaps are connected to each other by hook-and-loop fasteners, arranged on the outer surface of at least two of the outer side flaps.

25. The cushioning structure of claim 19, wherein the support elements comprise a rectangular tubular profile.

26. The cushioning structure of claim 19, comprising reinforcement elements separate from the main frame configured to be inserted into the supporting elements to further increase the resilience of the main frame to carry goods with weights of more than 30 kg, 40 kg, or 50 kg.

27. The cushioning structure of claim 26, wherein the reinforcement elements comprise a profile adapted to a profile of the supporting elements, wherein the reinforcement elements are configured to snuglyfit into the supporting elements.

28. The cushioning structure of claim 26, wherein the reinforcement elements are foldable into the profile adapted to the profile of the supporting elements and are collapsible into a two-dimensional structure.

29. The cushioning structure of claim 19, wherein the contiguous bearing surface, the inner and outer side flaps of the main frame, or the reinforcement elements comprise pressed paperboard.

30. The cushioning structure of claim 19, wherein the carrier foil comprises a urethane foil bonded to the main frame by ultrasonic pressure bonding.

31. A container for transporting goods, comprising:
a bottom section;
a midsection comprising a container side wall fitting into the bottom section;
at least a first cushioning structure and a second cushioning structure, wherein the first cushioning structure and the second cushioning structure comprise:
a main frame comprising a contiguous bearing surface, wherein the main frame comprises multiple foldable inner and outer side flaps, wherein the multiple foldable inner and outer side flaps are configured to be folded into multiple supporting elements of connected inner and outer side flaps to support a bearing surface of the main frame with a height defined by dimensions of the outer side flaps, and wherein the main frame comprises a profile to increase resilience of the main frame for carrying goods with weights of more than 25 kg, and wherein the main frame is configured to be collapsible into a two-dimensional structure; and
a carrier foil attached to the main frame, wherein the carrier foil fully covers the contiguous bearing surface, and wherein an area enclosed by the contiguous bearing surface comprises a carrying surface for the goods;
wherein the first cushioning structure comprises a bottom element fitting into the midsection, and wherein the first cushioning structure comprises a first carried foil, and wherein the first cushioning structure is configured to be placed on top of the bottom section with the first carrier foil facing upwards to carry goods, and wherein the second cushioning structure comprises a second carrier foil, and wherein the second cushioning structure is configured to be placed on top of the goods with the second carrier foil facing downwards to sandwich the goods between the first carrier foil and the second carrier foil; and
a top section fitting on top of the midsection configured to close the container.

32. The container of claim 31, wherein the bottom section, the top section and the midsection comprise pressed paperboard.

33. The container of claim 31, wherein the midsection is configured to be foldable fitting into the bottom section in a collapsed status, and wherein the midsection comprises at least one hook-and-loop fastener configured to be fixed to the first cushioning structure or the second cushioning structure.

34. The container of claim 31, wherein the midsection comprises a closing component configured to be fixed to the top section or the bottom section.

35. A method for loading goods in a container, comprising:
placing a midsection on top of a bottom section, wherein the container comprises:
a bottom section;
a midsection comprising a container side wall fitting into the bottom section;
at least a first cushioning structure and a second cushioning structure, wherein the first cushioning structure and the second cushioning structure comprise:
a main frame comprising a contiguous bearing surface, wherein the main frame comprises multiple foldable inner and outer side flaps, wherein the multiple foldable inner and outer side flaps are configured to be folded into multiple supporting elements of connected inner and outer side flaps to support a bearing surface of the main frame with a height defined by dimensions of the outer side flaps, and wherein the main frame comprises a profile to increase resilience of the main frame for carrying goods with weights of more than 25 kg, and wherein the main frame is configured to be collapsible into a two-dimensional structure; and
a carrier foil attached to the main frame, wherein the carrier foil fully covers the contiguous bearing surface, and wherein an area enclosed by the contiguous bearing surface comprises a carrying surface for the goods;
wherein the first cushioning structure comprises a bottom element fitting into the midsection, and wherein the first cushioning structure comprises a first carried foil, and wherein the first cushioning structure is configured to be placed on top of the bottom section with the first carrier foil facing upwards to carry goods, and wherein the second cushioning structure comprises a second carrier foil, and wherein the second cushioning structure is configured to be placed on top of the goods with the second carrier foil facing downwards to sandwich the goods between the first carrier foil and the second carrier foil; and
a top section fitting on top of the midsection configured to close the container;
placing the first cushioning structure into the midsection and on top of the bottom section with first carrier foil facing upwards;
placing the goods on top of the first carrier foil;
placing the second cushioning structure into the midsection and on top of the goods with the second carrier foil facing downwards, and
placing the top section over the second cushioning structure and the midsection in order to close the container; and
secure the closed containers with a securing strap.

36. A method for transporting a container, comprising:
collapsing a foldable midsection placing a midsection on top of a bottom section,
wherein the container comprises:
a bottom section;
a midsection comprising a container side wall fitting into the bottom section;
at least a first cushioning structure and a second cushioning structure, wherein the first cushioning structure and the second cushioning structure comprise:
a main frame comprising a contiguous bearing surface, wherein the main frame comprises multiple foldable inner and outer side flaps, wherein the multiple foldable inner and outer side flaps are configured to be folded into multiple supporting elements of connected inner and outer side flaps to support a bearing surface of the main frame with a height defined by dimensions of the outer side flaps, and wherein the main frame comprises a profile to increase resilience of the main frame for carrying goods with weights of more than 25 kg, and wherein the main frame is configured to be collapsible into a two-dimensional structure; and
a carrier foil attached to the main frame, wherein the carrier foil fully covers the contiguous bearing surface, and wherein an area enclosed by the contiguous bearing surface comprises a carrying surface for the goods;
wherein the first cushioning structure comprises a bottom element fitting into the midsection, and wherein the first cushioning structure comprises a first carried foil, and wherein the first cushioning structure is configured to be placed on top of the bottom section with the first carrier foil facing upwards to carry goods, and wherein the second cushioning structure comprises a second carrier foil, and wherein the second cushioning structure is configured to be placed on top of the goods with the second carrier foil facing downwards to sandwich the goods between the first carrier foil and the second carrier foil; and
a top section fitting on top of the midsection configured to close the container;
placing the collapsed midsection on top of the bottom section;
collapsing the first cushioning structure and the second cushioning structure by unfolding the support elements;
placing the first cushioning structure and the second cushioning structure on top of the bottom section or on top of the collapsed midsection together with reinforcement elements of the first cushioning structure or the second cushioning structure; and
placing the top section over the bottom section to close the container, wherein the container is reduced in size.
